(19) United States
(12) Patent Application Publication
(10) Pub. No.: US 2005/0233700 A1
(43) Pub. Date: Oct. 20, 2005

(54) System selection in wireless communications networks

(76) Inventors: Mark E. Pecen, Palatine, IL (US); Niels Peter Skov Andersen, Roskilde (DK); Sanjay Gupta, Lakewood, IL (US)

Correspondence Address: MOTOROLA INC, 600 NORTH US HIGHWAY 45, ROOM AS437, LIBERTYVILLE, IL, 60048-5343, US

(21) Appl. No.: 10/824,550

(22) Filed: Apr. 14, 2004

(51) Int. Cl. H04Q 7/20

(52) U.S. Cl. 455/67.11

(57) ABSTRACT

A method in a hybrid wireless communications device, including comparing a mobility measurement of the wireless communications device to a mobility threshold while connected to a broadband wireless network. In one embodiment, the mobility measure is computed based on signal measurement regression error. The wireless communications device enters a state (612) that monitors a cellular communications network if the mobility measurement is greater than a mobility threshold, and enters a state (614) not monitoring the cellular communications network if the mobility measurement is not greater than the mobility threshold.

### FIELD OF THE DISCLOSURE

The present disclosure relates generally to wireless communication, and more particularly to the selection of communications system by wireless communications devices capable of operating in different communications systems, for example, in cellular communications networks like GSM and in broadband wireless networks like 802.11, and methods therefor.

### BACKGROUND OF THE DISCLOSURE

The recent emergence of hybrid wireless cellular communications devices capable of communicating on both cellular networks and in broadband wireless networks, for example, 802.11 protocols WLAN networks presents new problems heretofore unconsidered. As the terminal moves physically and/or the fading channel changes due to subtle variations in the complexity of the physical surroundings, the cellular mobile terminal supports a specific set of logical decision-making capabilities that determines how a cell and/or network will be selected. Generally, a hybrid wireless communications devices may select one network or the other, or both.

Broadband wireless communication protocols support radio resource management techniques for selecting one or more operating frequencies and access points. A cellular system, such as Global System for Mobile telecommunication (GSM), however, has little in common with alternate radio access interfaces, for example, a standardized WLAN like 802.11 or some other wireless technology capable of meeting the requirements of operation in unlicensed spectrum. The differences in radio behavior result primarily from differences in operating bandwidth, power limitations for unlicensed operation, Medium Access Control (MAC) protocol (either reservation-based or contention-based) designed to handle different predominant traffic types, frequency range of operation and accordingly, the resulting difference in radio propagation characteristics and the interference environment for licensed/unlicensed operation.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 is an exemplary wireless communications network including cellular and broadband wireless systems.

FIG. 2 illustrates an exemplary architecture for a hybrid wireless communication device.

FIG. 3 is an exemplary regression line based on temporally varying signal level measurements.

FIG. 4 is an exemplary schematic broadband wireless signal-processing diagram.

FIG. 5 is an exemplary schematic cellular wireless signal-processing diagram.

FIG. 6 is an exemplary hybrid wireless communications device state diagram.

FIG. 7 is a graphical illustration of exemplary cellular network selection behavior of a wireless communications device.

FIG. 8 illustrates exemplary cell selection datum.

FIG. 9 illustrates linked cell re/selection data.

### DETAILED DESCRIPTION

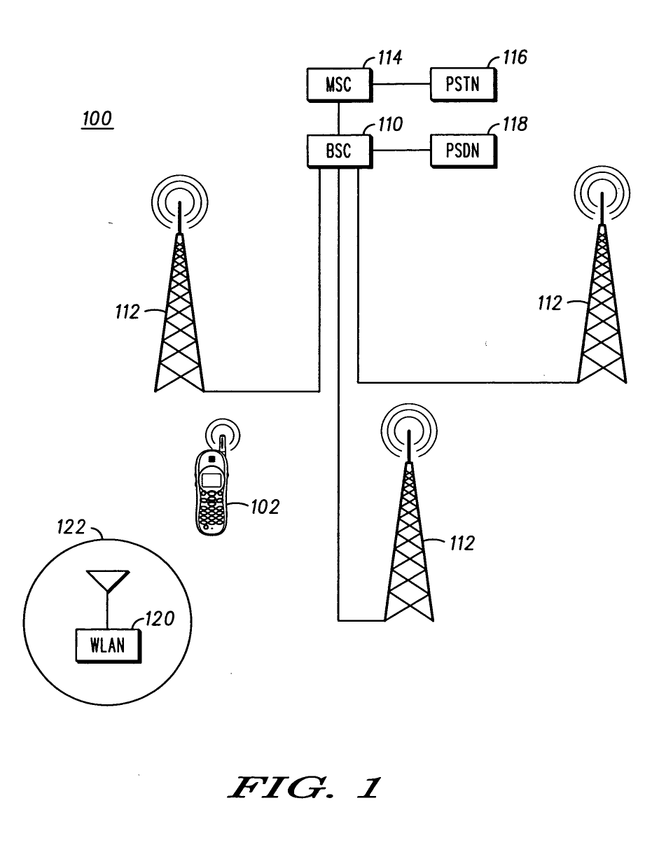

FIG. 1 illustrates a hybrid wireless communications device 102 operating in a wireless communications network 100 comprising first and second generally different communication systems. The exemplary first system is a cellular communications network or system, for example, a Global System for Mobile communications (GSM) comprising a base station controller (BSC) 110 coupled to a plurality of base transceiver stations (BTS) 112 and to a mobile switching center (MSC) 114 interconnecting the BSC to a Public Switched Telephone Network (PSTN) 116. The exemplary cellular communications system is coupled to a data network, for example, a General Packet Radio Service (GPRS) or some other Packet/Public Switched Data (PSDN) 118 network by infrastructure well known to those having ordinary skill in the art. The exemplary cellular communications system may also be coupled to other entities and infrastructure, for example, messaging and/or presence servers not illustrated but also well known by those having ordinary skill in the art. In other embodiments, the cellular communications network may be some other protocol network, for example, a CDMA network or a 3^{rd} Generation (3G) W-CDMA network, or a combination of 2G and 3 G networks, among others.

In FIG. 1, the exemplary second system is a broadband wireless communications network, for example, a wireless local area network (WLAN) 120. Alternatively, the broadband wireless communications network may be a canopy or other fixed wireless network. The broadband wireless network may be proprietary or standardized protocol, for example, an 802.11 protocol network or some other wireless technology capable of meeting the requirements of operation in unlicensed spectrum. In other embodiments, more generally, the second system may be some other network, which is generally isolated relative to the cellular network.

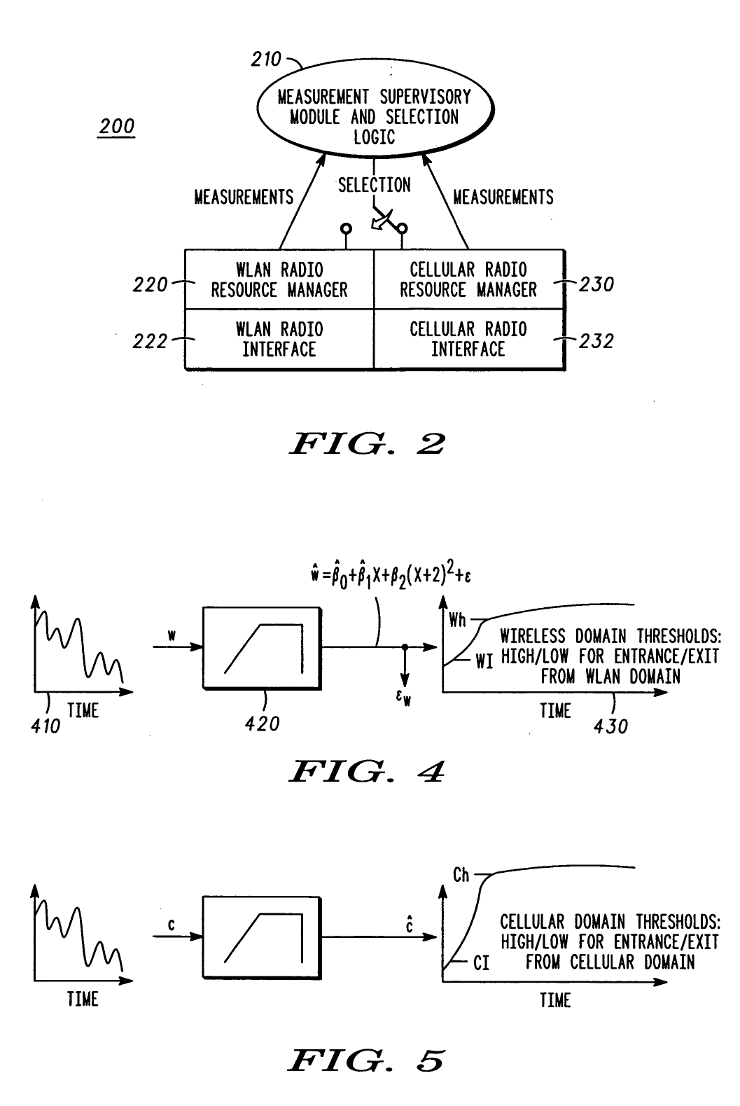

FIG. 2 illustrates a portion of a wireless communications device architecture 200 comprises a supervisory entity 210 that manages wireless signal measurements and communications system selection logic. The exemplary architecture includes a WLAN radio resource manager 220 coupled to a WLAN radio interface 222 and a cellular radio resource manager 230 coupled to a cellular radio interface 232. The radio resource managers 220 and 230 communicate signal measurements to the management entity 210, and the management entity controls the selection and monitoring of the first and second radio systems based on signal measurement information, as discussed further below. In other embodiments, the radio resource management and interface entities may be different than those of the exemplary embodiment.

According to one aspect of the disclosure, the wireless communications device obtains a measure of its mobility. Exemplary embodiments for computing mobility are discussed further below. In some embodiments, the wireless communications device uses the measure of mobility as a basis for determining whether and/or when to select or reselect a communication system. The wireless communications device may also use the mobility measure to determine whether and/or when to search or monitor and/or scan for a communication system. In other embodiments, the measure of mobility is determined by or communicated to the communication system or network, and the system uses the mobility measure as a basis for assigning traffic channels in a micro or macro-environment, among other uses.

In one embodiment, the measure of mobility is based on regression error of system signal measurements. FIG. 3 illustrates exemplary predictions for multiple signal measurements made over corresponding time intervals, or windows “Wᵢ”, “Wᵢ₊₁”. . . , each window “W” comprising “N” measurements “s”. A regression of all “s” within a window “W” is performed to predict Ŷ according to the following formula:
Ŷⱼ=\hat{β}₀+\hat{β}₁sⱼ+\hat{β}₂(sⱼ+α)²+ε Equation (1)
where Ŷ is an estimate of the actual signal level s. Terms β_{{0,1,2 }} and α are coefficients selected to minimize the error term, ε, which is the square root of the mean squared error of the difference between the actual value and predicted values of signal strengths, and is expressed as:

$$ɛ = \sqrt{\frac{1}{N} {\sum }_{j = 1}^{N} {( {s}_{j} - {\hat{Y}}_{j} )}^{2}} \qquad Equation ( 2 )$$

The regression line traced by the value of Ŷ may be linear or curved depending on the order thereof. The value of ε is related to the consistency of signal strength due to time-varying effects of the fading channel, and generally increases as the mobility of the wireless communications device increases, and decreases as the mobility of the wireless communications device decreases.

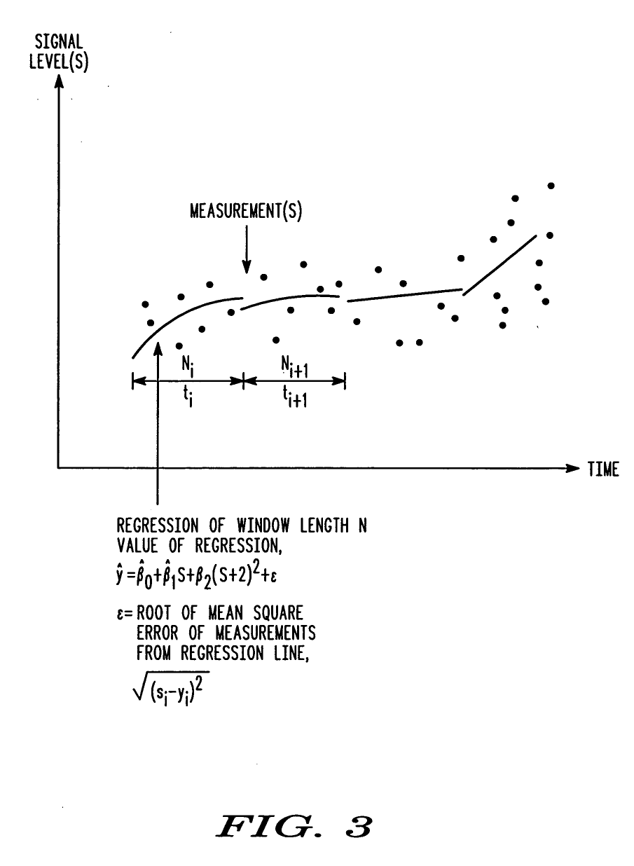

In FIG. 4, the amplitude of the broadband wireless signal w is the received signal strength indication (RSSI) and/or other channel quality measurement, for example, bit error rate (BER), block erasure rate (BLER), etc., is illustrated at 410. The broadband wireless signal w is filtered and/or subject to a multiple regression operation at 420, the output of which is expressed as “ŵ”, the general form of which is given by Equation (1) above. The corresponding error component “ε_{w}” is indicative the mobility of the wireless communications device. In FIG. 5, at 510, the amplitude of the cellular signal “c” is a received signal strength indication (RSSI) and/or other channel quality measurement, for example, bit error rate (BER), block erasure rate (BLER), etc. The signal “c” is filtered and or subject to a multiple regression operation at 520 the output of which is expressed as “ĉ”, the general form of which is also given by Equation (1).

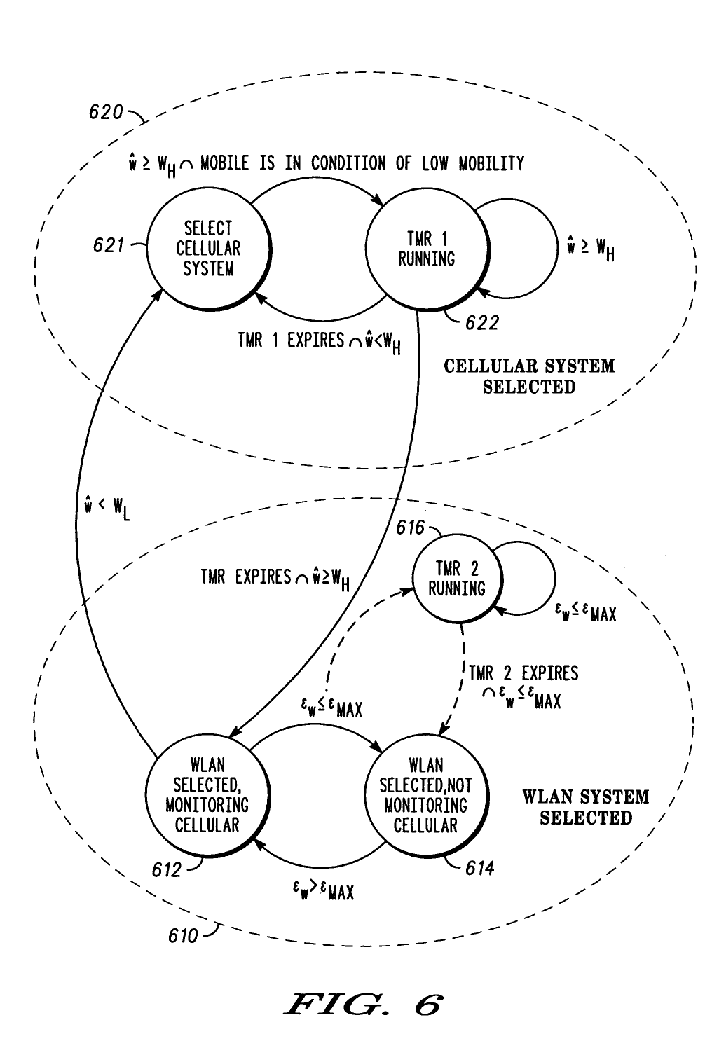

In the exemplary state diagram 600 of FIG. 6, the wireless communications device selected on the broadband wireless network, e.g., the WLAN, state 610, monitors the cellular system at state 612 if the measure of its mobility “ε_{w}” exceeds a mobility threshold “ε_{MAX}”. The wireless communications device selected on the broadband wireless network, e.g., the WLAN, at state 610 changes to state 614, where the cellular system is not monitored, if the measure of its mobility “ε_{w}” does not exceed, or is less than or equal to, the mobility threshold “ε_{MAX}”. In some embodiments, the wireless communications device at state 612 will not change to state 614 unless the measure of its mobility “ε_{w}” remains less than or equal to the mobility threshold “ε_{MAX}” for a specified time period, TMR₂ indicated at state 616.

In FIG. 6, in one embodiment, the wireless communications device changes from the exemplary WLAN or other broadband wireless selected state 610 to the cellular system selected state 620 if the signal estimate ŵ is less than a lower threshold “W_{L}” below which the wireless communications device cannot remain connected to the broadband system. FIG. 4 illustrates an upper threshold “W_{U}” and the lower threshold “W_{L}” at 430. The upper threshold “W_{U}” indicates suitability for the wireless communications device to select the broadband wireless system or network, as discussed more fully below. In some embodiments, the threshold “W_{U}” is dynamic to compensate for changes in regression error of the signal measurements.

In FIG. 6, at the cellular selected state 622, the wireless mobile communications device selects or transitions from the cellular selected state 620 to the broadband wireless, e.g., WLAN, selected state 610 if the signal estimate ŵ exceeds the upper threshold “W_{U}” above which it is suitable for the wireless communications device to select the broadband wireless system or network. In the exemplary embodiment, the wireless communications device does not change from state 520 to state 510 until or unless the signal estimate “ŵ” exceeds the upper threshold “W_{U}” for a specified time period indicated at TMR₁ state 522. Upon satisfaction of the condition and expiration of the timer at state 522, the wireless communications device transitions to state 512. In some embodiments, the threshold “W_{U}” is dynamic to compensate for changes in regression error of the signal measurements. In such embodiments, the value of W_{U} would be intelligently manipulated depending on the value of the error term ε to compensate for the uncertainty produced in high mobility or highly variable environments.

The use of the TMR₁ condition before allowing selection of the broadband wireless network from the cellular network eliminates or at least reduces short-lived re/selections caused by transient and/or spurious increases in signal strength measurements on the broadband wireless network or system. Broadband wireless system signal strength transients may occur, for example, when the wireless communications device makes a fleeting passage through a WLAN coverage area. Other conditions may also give rise to transient periods during which the broadband signal or signal estimate exceeds the upper threshold “W_{U}”. This behavior is likely to occur when the mobile terminal has selected to a cellular system in idle mode, but has moved through an area of WLAN access points. This effect may be particularly pronounced when the mobile terminal device passes an aperture such as a window or door of a building having WLAN access points located on the other side.

In some embodiments, eliminating or reducing failed or transient reselections also eliminates or reduces unnecessary cellular network Routing Area Updates and unnecessary consumption of network signaling capacity and reduced unnecessary consumption of communications device battery life. Additionally, wireless communication devices tend to consume more battery power during attempts to remain synchronized to both systems when it is more appropriate to remain active on only one system or the other.

In other embodiments, the measure of mobility is based on other factors or schemes. For wireless communications devices in the cellular system selected state 520, for example, the mobility measurement may be based on cell selection information. One exemplary way to characterize the problem domain is to consider the operational environment of the mobile communications device or terminal as a universe of “visited cells”, each having its own characteristic, e.g. the last time the cell was selected, the number of times the cell was selected, etc. This concept may be developed further by considering such a universe of cells as a dynamic non-deterministic finite automaton (NFA), i.e. an NFA that would dynamically grow and shrink based primarily on two conditions: 1) the number of cells visited and 2) the last time each cell was visited. The NFA was chosen as a starting point because it is simpler to view a smaller number of state transitions as compared to a deterministic finite automaton (DFA). It is nevertheless possible to convert the NFA to a DFA, for example, if there is a benefit related to the ability of backtracking through previous states.

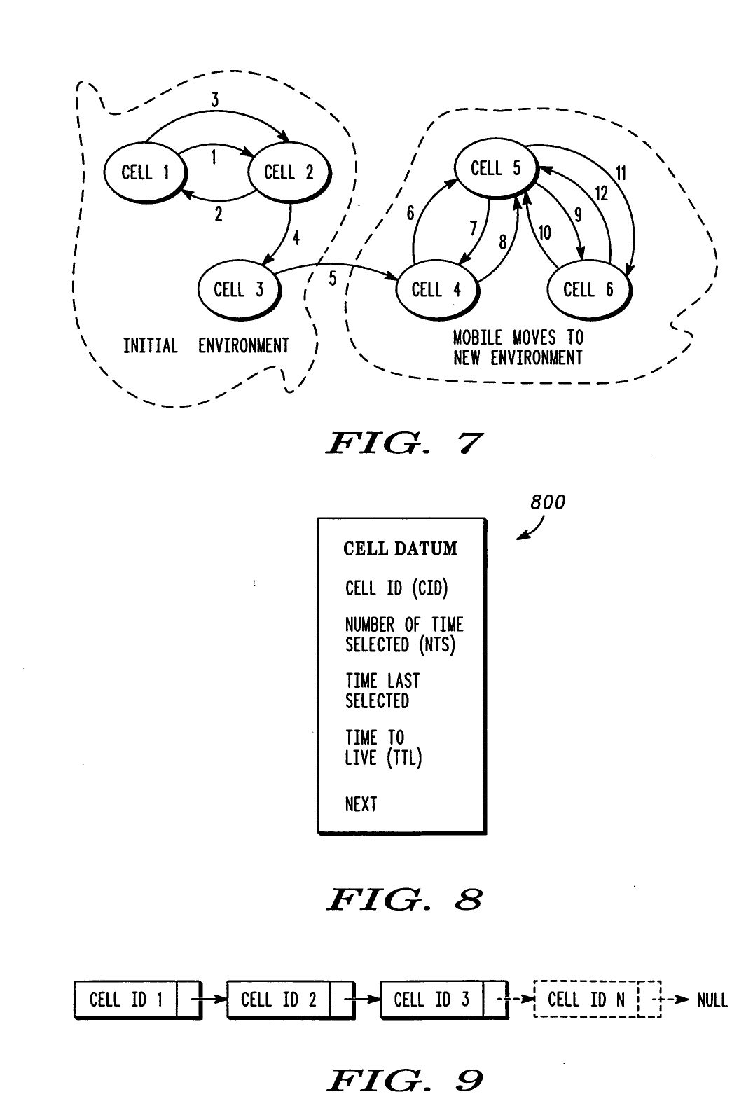

Consider a mobile terminal traversing an operating environment in terms of the DFA model. In FIG. 7, for example, the mobile terminal begins initially at cell 1, selects cell 2, and returns to cell 1 before selecting cell 2 and then selecting cell 3. The initial environment may be considered to be cells 1, 2 and 3. The breadth of the environment provides an indication or estimation of whether the mobile terminal is moving quickly or slowly or not at all. Generally, the greater the number of different cells visited during or within a given period, the more likely the mobile terminal is moving. The rate at which the mobile is traversing environments is more important than the actual speed. Thus selection among only 3 cells is less significant than if the mobile is selecting among many different cells. In FIG. 7, for example, the several selections between only cells 1 and 2 is indicative that the wireless communications device is likely stationary or at least not moving rapidly. The selection of cell 4 and subsequent selection among cells 4, 5 and 6 is indicative that the mobile terminal is moving and is most certainly in a wider area environment. If cells that have not been visited for a while have been eliminated, a new environment, for example, cells 4, 5 and 6 in FIG. 7 may be considered. In the new environment, the NFA breadth is again 3, which implies again the mobile is in another relatively low velocity environment.

One exemplary realization of the model, using a graph-theory method, includes defining a datum for each cell to which the mobile re/selects. FIG. 8 illustrates an exemplary cell datum 800, including cell ID (CID), the number of times the cell was selected (NTS), the last time the cell was selected, and the time to live (TTL). As cells are selected, the datum is inserted into a singly linked list as illustrated in FIG. 9. The idea is generally to superimpose the NFA construct over the construct of the linked list. An exemplary algorithm follows:

```
START (Each time the mobile station reselects to new cell)
  FOR ( all list data )
  IF ( Time NOW - Datum->TLS > Datum->TTL )
  THEN remove datum from list
  FI
  ENDFOR
  Search for CID on existing list
  IF ( CID not on list OR list empty )
  THEN Create new datum
  ELSE ( i.e. if datum for CID found )
  Update datum info
  Datum->NTS++
  Datum->TLS = time NOW
  FI
    ⊙
  Set ListCount = 0
  FOR ( all list data )
  ListCount++
  ENDFOR
  Additionally, save the NFA on a separate list and maybe analyze this as
  well:
  Add Reselected Cell ( &Saved List )
  Evaluate ListCount value, i.e. above some threshold may indicate fast
  velocity
END
```

As suggested, the mobility measure may be made by or on the mobile communications device or by or within the communication system or network or by both entities. For wireless communications devices in cellular systems or networks, the mobility measurement may be used for making optimal traffic channel assignments, to determine when or whether the device is assigned a traffic channel on a micro-cell or macro-cell environment. The mobility measurement may also be used for determining whether the wireless communications device should be periodically scanning for a broadband wireless network. For example, if the wireless communications device is selecting between the same few cells and there is no possibility of obtaining broadband wireless service, then the mobile terminal should not expend resources scanning for the broadband wireless service. For example, the mobile device may be in an area of no broadband wireless service for days, during which it makes no sense to scan for such service. As soon as the mobile device determines that it is in motion based on the mobility measure, however, then periodic broadband wireless scanning should resume.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

1. A method in a wireless communications device, the method comprising:
obtaining a measure of mobility of the wireless communications;
monitoring a first system whiles selected to a second system only if the measure of mobility exceeds a mobility threshold.

2. The method of claim 1, obtaining the measure of mobility based on a regression error of a signal measurement on the second system.

3. The method of claim 1, monitoring the first system includes obtaining a signal measurement from the first system and synchronizing with the first system.

4. The method of claim 1, selecting the first system if a signal measurement of the second system drops below a second system lower threshold.

5. The method of claim 1,
selecting the first system and deselecting the second system if the signal measurement of the second system drops below a second system lower threshold,
re-selecting the second system if the signal measurement of the second system exceeds a second system upper threshold for a predetermined time period after selecting the first system.

6. The method of claim 5,
monitoring the first system after reselecting the second system,
discontinuing monitoring the first system if the measure of mobility is not greater than the mobility threshold.

7. The method of claim 1,
obtaining the measure of mobility based on cell selection information obtained while selected to the second system,
monitoring the first system while selected to the second system only if the measure of mobility exceeds the mobility threshold.

8. The method of claim 1,
the second system is a cellular system,
obtaining the measure of mobility based on number of different cells selected while selected to the second system.

9. The method of claim 2, obtaining the signal measurement based on any one of a received signal strength indication, bit error rate information, and block erasure rate information.

10. A method in a hybrid wireless communications device, the method comprising:
comparing a mobility measurement of the wireless communications device to a mobility threshold while connected to a broadband wireless network;
monitoring a cellular communications network if the mobility measurement is greater than a mobility threshold;
not monitoring the cellular communications network if the mobility measurement is not greater than the mobility threshold.

11. The method of claim 10, determining the mobility measurement from regression error information of a signal measurement on the broadband wireless network.

12. The method of claim 11, determining the mobility measurement based on a root mean square of the regression error information.

13. The method of claim 10, selecting the cellular communications network if a signal measurement on the broadband wireless network is less than a lower threshold.

14. The method of claim 13,
selecting the broadband wireless network if the signal measurement on the broadband wireless network is greater than or equal to an upper threshold for a specified time period,
remaining on the cellular communications network if the signal measurement on the broadband wireless network is not greater than or equal to the upper threshold for the specified time period.

15. The method of claim 11, obtaining the signal measurement based on any one of received signal strength indication information, bit error rate information, and block erasure rate information.

16. A method in a wireless communications device capable of communicating in a cellular communications network and in a broadband wireless network, the method comprising:
determining regression line error information based on broadband wireless network signal measurements;
monitoring a cellular communications network if the error information is greater than a threshold;
not monitoring the cellular communications network if the error information is not greater than the threshold.

17. The method of claim 16, determining regression line error information includes determining a root mean square of regression error associated with a regression line.

18. The method of claim 16, selecting the cellular communications network if a signal measurement on the broadband wireless network is less than a lower threshold.

19. The method of claim 18,
selecting the broadband wireless network if signal measurements on the broadband wireless network is greater than or equal to an upper threshold for a specified time period,
remaining on the cellular communications network if the signal measurement on the broadband wireless network is not greater than or equal to the upper threshold for the specified time period.

20. A method in a wireless communications device operable on first and second wireless communication systems, the method comprising:
operating on the first wireless communications system;
making signal measurements on the second wireless communications system;
selecting the second wireless communications system if signal measurements on the second wireless communications system exceeds a dynamic threshold for a specified time period,
the dynamic threshold compensates for changes in regression error of the signal measurements on the second wireless communications system.

21. The method of claim 20, making signal measurements based upon any one of received signal strength indication information, bit error rate information, and block erasure rate information.

22. A method in a wireless communications device, the method comprising:
obtaining a measure of mobility of the wireless communications while selected to a cellular wireless communication system;
monitoring for a broadband wireless communication system while selected to the cellular wireless communications system only if the measure of mobility exceeds a mobility threshold.

23. The method of claim 22,
obtaining the measure of mobility based on changes in a universe of different cells selected while selected to the second system.
